(19) United States
(12) Patent Application Publication
(10) Pub. No.: US 2013/0241717 A1
(43) Pub. Date: Sep. 19, 2013

(54) MOBILE HIGH-DEFINITION LINK WITH BUILT-IN POWER SUPPLY

(71) Applicant: CHIN-MIN CHOU, New Taipei City (TW)

(72) Inventor: CHIN-MIN CHOU, New Taipei City (TW)

(21) Appl. No.: 13/419,448

(22) Filed: Mar. 14, 2012

(51) Int. Cl. G08C 19/00; H02J 9/00

(52) U.S. Cl. 340/286.01; 307/66

(57) ABSTRACT

A mobile high-definition link with built-in power supply includes an adaptor module, a power supply module, and a battery. The power supply module is automatically or manually switchable between the battery and an external power source. When a transfer unit is to transfer a signal from a smart mobile phone or a tablet computer to a displaying device, a detection module automatically activates the transfer unit by using electrical power supplied from the power supply module. The power supply module may select the battery or the external power source based on a result of detection so as to realize a power saving function of automatic detection and activation/deactivation of the battery power source and also provide an advantage of requiring no seeking for an external power supply.

### TECHNICAL FIELD OF THE INVENTION

The present invention generally relates to a mobile high-definition link, and more particularly to a mobile high-definition link with built-in power supply that features a power-saving function of automatic detection and activation/deactivation a battery power source so that seeking for an external power supply is not necessary.

### DESCRIPTION OF THE PRIOR ART

A smart mobile phone (using an Android system) has a function of transmitting videos and contents to a displaying device to be displayed thereby. However, such as function can only be performed by using a mobile high-definition link. Consequently, what is currently now available in the market is a device that can only be connected when an external power supply is available; otherwise it cannot be operated where no external power supply is available.

Overcoming such a problem is a major issue of the industry and is a goal that the present invention aims to achieve.

### SUMMARY OF THE INVENTION

In view of the above problem and drawback, the present invention aims to provide a mobile high-definition link with built-in power supply that features a power-saving function of automatic detection and activation/deactivation a battery power source so that seeking for an external power supply is not necessary

The primary object of the present invention is to provide a solution that overcomes the problem that a conventional mobile high-definition link may not be operated due to it being hard to find an external power supply by providing a power-saving function of automatic detection and activation/deactivation a battery power source so that seeking for an external power supply is not necessary.

To achieve the above object, the present invention provides a mobile high-definition link with built-in power supply, which comprises: an adaptor module, a power supply module, and a battery. The power supply module is contained in the adaptor module and is electrically connected to an external power source. The adaptor module contains therein the battery, and the battery is electrically connected to the power supply module. The power supply module is automatically or manually switchable. The adaptor module comprises a transfer unit, which transfers a signal from a mobile device to a displaying device. The transfer unit is in information communication with the power supply module. The transfer unit forms a first interface with respect to the mobile device and also forms a second interface with respect to the displaying device, wherein the mobile device can be a smart mobile phone or a tablet computer and the displaying device can be a television set or a projector. The first interface and the second interface are in information communication with a detection module, which is in information communication with the power supply module. With the above arrangement, the power supply module is automatically or manually switchable to the external power source or the battery. When the transfer unit is to transfer a signal from the smart mobile phone or tablet computer to the displaying device, the adaptor module is automatically activated and uses the electrical power supplied from the power supply module to thereby realizes a power saving function of automatic detection and activation/deactivation of the battery power source and also provide an advantage of requiring no seeking for an external power supply.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective showing an application of the present invention.

FIG. 2 is a perspective view of the present invention.

FIG. 3 is a block diagram of the present invention.

FIG. 4 is a perspective view showing the present invention being operated with the battery.

FIG. 5 is a perspective view showing the present invention being operated with an external power supply.

FIG. 6 is a perspective view showing the present invention carrying out a charging operation.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

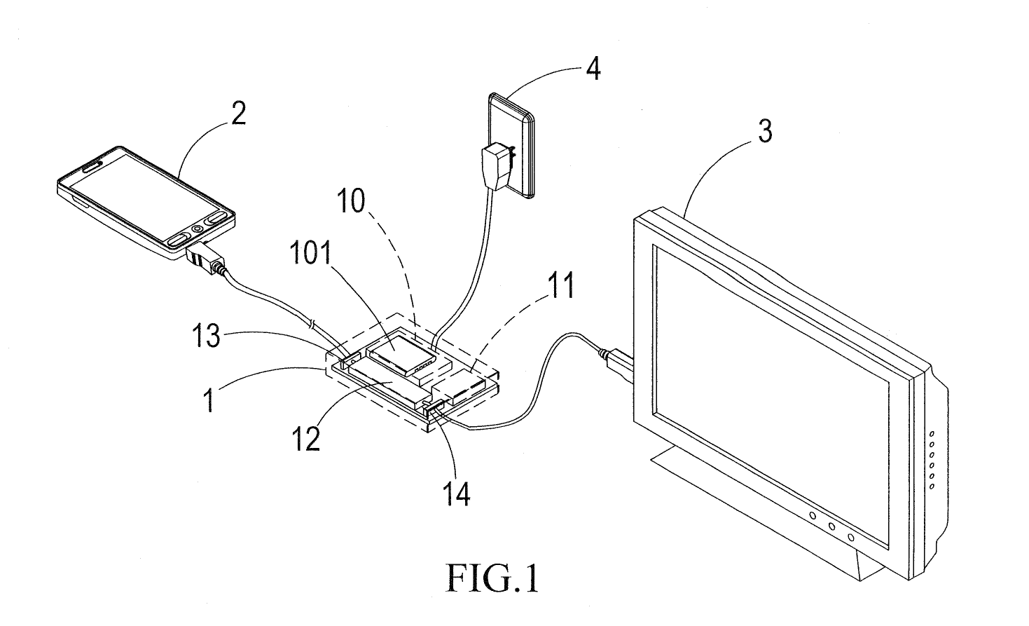

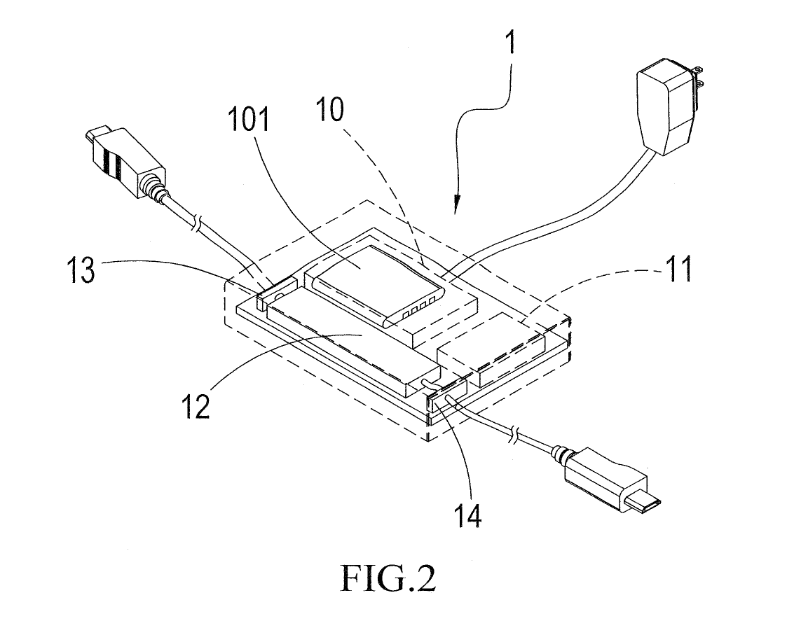

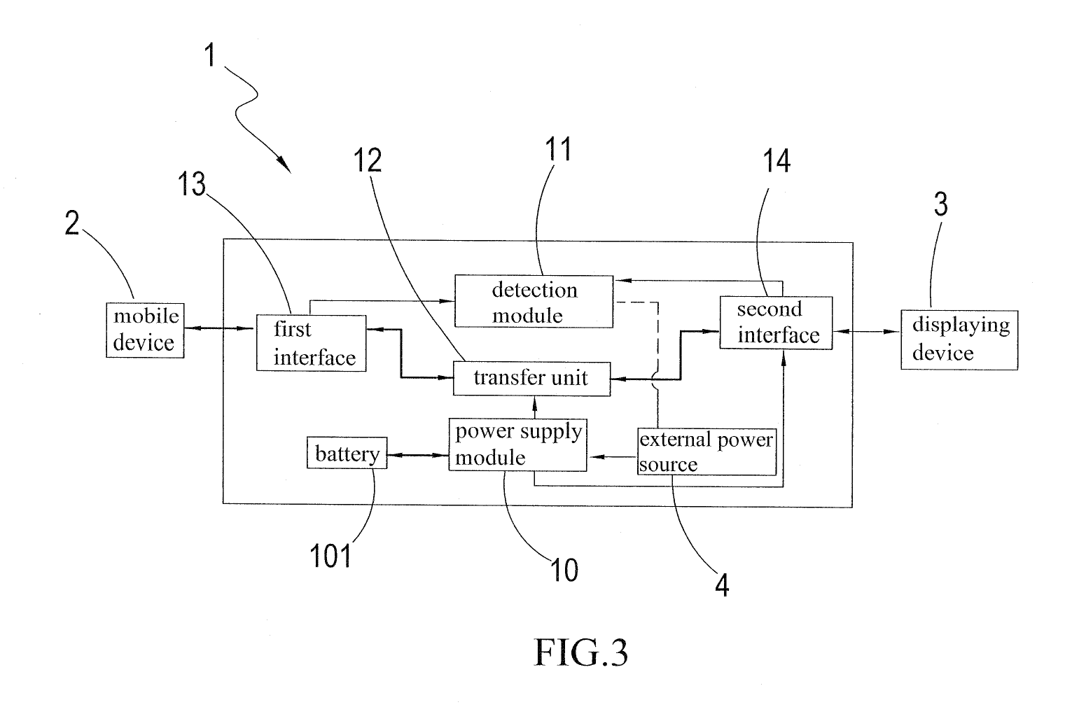

Referring to FIGS. 1, 2, and 3, which are respectively a perspective showing an application of the present invention and a perspective view and a block diagram of the present invention, these drawings clearly show that the present invention provides a mobile high-definition link with built-in power supply, which comprises: an adaptor module 1, a power supply module 10, and a battery 101. The power supply module 10 is arranged inside the adaptor module 1 and the power supply module 10 is electrically connected to an external power source 4. The adaptor module 1 contains the battery 101 therein. The battery 101 is electrically connected to the power supply module 10. The power supply module 10 is automatically or manually switchable between the external power source 4 and the battery 101. The adaptor module 1 contains therein a transfer unit 12 and the transfer unit 12 transfers a signal from a mobile device 2 to a displaying device 3. A first interface 13 is formed between the transfer unit 12 and the mobile device 2 and a second interface 14 is formed between the transfer unit 12 and the displaying device 3. The transfer unit 12 is in information communication with the power supply module 10. The mobile device 2 can be a smart mobile phone or a tablet computer, and the displaying device 3 can e a television set or a projector. The first interface 13 and/or the second interface 14 is in information communication with a detection module 11, and the detection module 11 is in information communication with the power supply module 10.

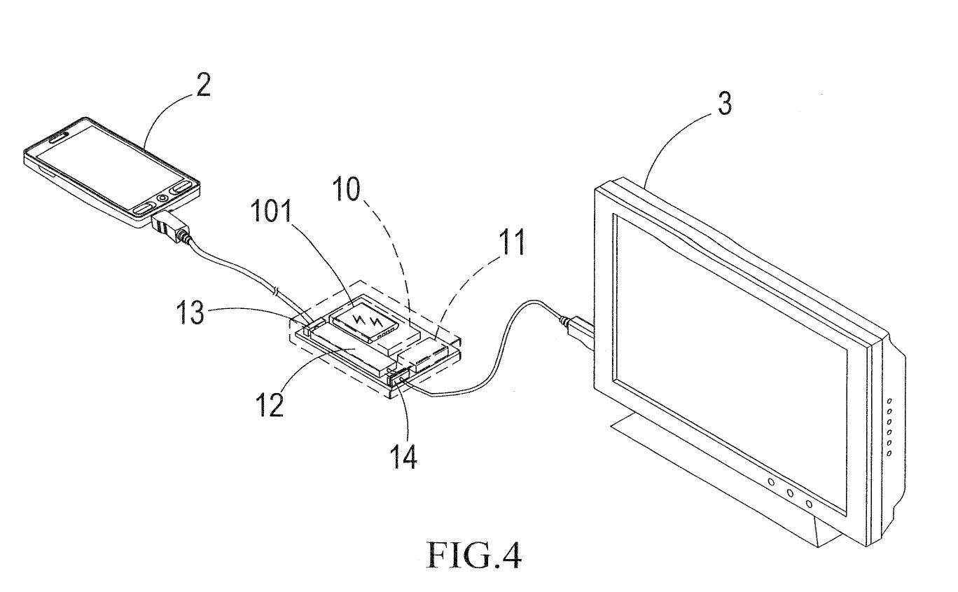

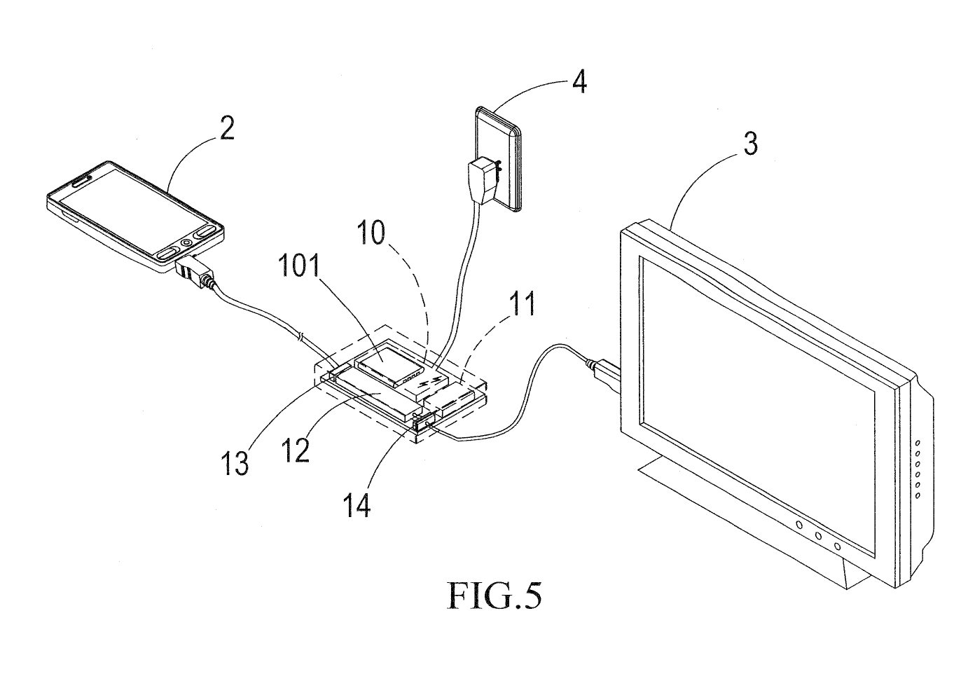

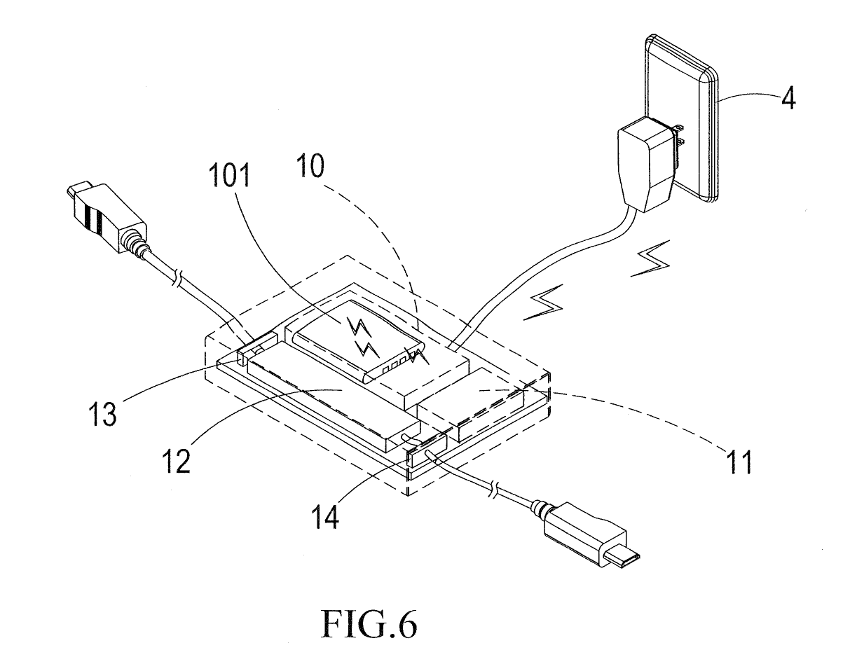

With the above arrangement, the operation of the present invention will be described, reference being had to FIGS. 1, 3, 4, 5, and 6, which are respectively a perspective showing an application of the present invention, a block diagram of the present invention, and perspective views showing the present invention being operated with the battery, the present invention being operated with an external power supply, and the present invention carrying out a charging operation, the drawings clearly show that when the transfer unit 12 receives a signal indicating the mobile device 2 (a smart mobile phone or a tablet computer being taken as an example but not limited thereto) or the displaying device 3 (a television set or a projector being taken as an example but not limited thereto) connecting to the first interface 13 or the second interface 14, the detection module 11 automatically activates the transfer unit 12 to use the electrical power supplied from the power supply module 10 in order to save the power of the battery 101. Further, when the power supply module 10 is not yet set in electrical connection with the external power source 4, supply of electrical power from the battery 101 will be effected so that there is no need to hurry to find an external power source 4. When the power supply module 10 is in electrical connection with the external power source 4, automatic switching of the power supply module 10 or manual switching may be done to switch to the external power source 4 or the battery 101. (Here, automatic switching of the power supply module 10 is taken as an example for illustration.) When connection to the external power source 4 is not yet established, the power supply module 10 receives electrical power from the battery 101 in priority and when connection to the external power source 4 is made, the power supply module 10 receives electrical power from the external power source 4 in priority and charges the battery 101 simultaneously. When signal connection to the displaying device 3 or the mobile device 2 is broken, the external power source 4 may still maintain the charging operation to the battery 101. Thus, advantages of easy use and saving power of the battery 101 can both be realized.

The description made above is provided for illustrating a preferred embodiment of the present invention only and it is apparent that the present invention is not limited to such an example or embodiment. All the possible modification and equivalent structures that are apparent to those having ordinary skill upon reading the above description are considered within the protection scope to be sought by the appended claims.

Reference is now made to all the drawings, compared to the conventional devices, the present invention shows the following advantages:

(1) Upon the mobile device 2 (a smart mobile phone or a tablet computer) or the displaying device 3 being connected to the first interface 13 or the second interface 14, the detection module 11 automatically activates the transfer unit 12 and the power supply module 10, in order to save electrical power of the battery 101.

(2) When the power supply module 10 is set in electrical connection with an external power source 4, automatic or manual switching may be made to select supply of electrical power from the external power source 4 or the battery 101.

(3) When the power supply module 10 is not yet in electrical connection with the external power source 4, electrical power is supplied from the battery 101, so that there is no hurry to seek for an external power source 4.

(4) The external power source 4 may supply electrical power to charge the battery 101, so that the electrical power of the battery 101 can be saved and easy use can be realized.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mobile high-definition link with built-in power supply, comprising:
an adaptor module, which comprises therein a detection module;
a power supply module, which is arranged inside the adaptor module and is in information communication with the detection module; and
a battery, which is contained in the adaptor module and is in electrical connection with the power supply module.

2. The mobile high-definition link with built-in power supply according to claim 1, wherein the adaptor module comprises a transfer unit, which is adapted to transfer a signal from a mobile device to a displaying device, the transfer unit forming a first interface with respect to the mobile device and a second interface with respect to the displaying device.

3. The mobile high-definition link with built-in power supply according to claim 2, wherein the transfer unit is in information communication with the power supply module.

4. The mobile high-definition link with built-in power supply according to claim 2, wherein the mobile device is one of a smart mobile phone and a tablet computer.

5. The mobile high-definition link with built-in power supply according to claim 2, wherein the displaying device is one of a television set or a projector.

6. The mobile high-definition link with built-in power supply according to claim 2, wherein the first interface or the second interface is in formation communication with the detection module.

7. The mobile high-definition link with built-in power supply according to claim 1, wherein the power supply module is automatically switchable.

8. The mobile high-definition link with built-in power supply according to claim 1, wherein the power supply module is manually switchable.

9. The mobile high-definition link with built-in power supply according to claim 1, wherein the power supply module is in electrical connection with an external power source.
